(19) United States
(12) Patent Application Publication
(10) Pub. No.: US 2007/0175099 A1
(43) Pub. Date: Aug. 2, 2007

(54) DRIVE ARRANGEMENT FOR MOTORIZED MOVEMENT OF A MOTOR VEHICLE DOOR OR THE LIKE

(75) Inventor: Checrallah KACHOUH, Dortmund (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/567,891

(22) Filed: Dec. 7, 2006

(30) Foreign Application Priority Data
Dec. 7, 2005 (DE) 20 2005 019 197.3
Dec. 21, 2005 (DE) 20 2005 020 087.5

(51) Int. Cl. E05F 15/02

(52) U.S. Cl. 49/340; 49/343

(57) ABSTRACT

A drive arrangement is provided for motorized pivotal movement of a vehicle door. The drive has a self-locking motor unit, a gear connected downstream of the motor unit for producing linear drive movement, and a clutch connected therebetween. The clutch can be moved into an engaged state in which the motor unit for nominal operation is engaged to the vehicle door. When the motor unit is turned off, manual movement of the vehicle door is blocked. The clutch can be moved into a released state in which the motor unit is separated from the vehicle door in terms of drive engineering. The clutch can be moved into the intermediate engaged state with reduced transmission moment and force so that the vehicle door is kept in its current position at any time by self-locking of the motor unit, but can be moved by manual actuation with a minimum actuation force.

### BACKGROUND OF THE INVENTION

1. Field of the Invention

This invention relates to a drive arrangement for motorized movement of a motor vehicle door.

2. Discussion of Related Art

The concept of a motor vehicle door disclosed herein is intended to encompass various access openings for a vehicle, including for example the side door of a motor vehicle, the rear hatch, the trunk lid, the hood, the cargo space hatch, and the roof, which may be raised or lifted. As described, the vehicle door is not included as part of the body of the vehicle. Rather, the vehicle door is coupled to the body of the motor vehicle to pivot around a pivoting axis, by which a door opening of the vehicle body can be closed.

One known drive arrangement for motorized movement of a motor vehicle door is disclosed in U.S. Pat. No. 3,398,484. This drive arrangement has a drive that is equipped with a motor unit and a spindle-spindle nut gear connected downstream of the motor unit to produce linear driving movement. The drive is located in the vehicle door and has a transmission element that projects outwardly through a gap in the vehicle door. The transmission element is coupled to the vehicle body in the region of the front of the vehicle door. The motor unit is not self locking. To prevent unwanted slamming of the vehicle door, for example when the vehicle has been parked on an incline, the motor unit can apply a counter torque to brake the movement in the unactuated state. However, in an emergency, for example when the voltage supply fails or a cable breaks, there is the danger of a malfunction of the braking. The operating reliability of this drive arrangement in an emergency is therefore greatly limited.

Another known drive arrangement is disclosed in U.S. Pat. No. 6,516,567, which is designed for the lift gate of a motor vehicle. The drive is equipped with a motor unit and a downstream spindle-spindle nut gear. The motor unit is self-locking. In order to ensure manual operation, a clutch is connected between the motor unit and the spindle-spindle nut gear. The same principle is followed in another known drive arrangement disclosed in U.S. Patent Publication No. 2004/0097318 in which the use of a planetary gear as a clutch is provided.

The known drive arrangements do not fully meet current requirements, specifically of optimum motorized operating behavior, manual actuation capacity and optimum operating behavior in an emergency. In particular, easy manual actuation capacity, on the one hand, and reliable operating behavior in an emergency, on the other hand, impose contradictory requirements on the drive arrangement, which no existing drive arrangement satisfies at the same time.

With respect to use of spindle-spindle nut gears, one reason these requirements have not been met is that the spindle-spindle nut gears that have been available to date have established limits, especially for manual actuation capacity. In manual actuation, generally a manual driving force is delivered into the spindle nut, which leads to rotation of the spindle backwards. Depending on the spindle pitch, jamming can easily occur, especially when the spindle is braked.

There is a need for a motorized drive assembly that can operate manually and in an emergency situation.

### SUMMARY OF THE INVENTION

An aspect of embodiments of this invention is to embody and develop a drive arrangement such that the operating behavior of the drive arrangement is optimized in an emergency, for example when the voltage supply fails.

In accordance with the invention, the drive arrangement allows a clutch to be moved into an engaged state and into a released state. In addition, the clutch can be moved into an intermediate engaged state with reduced transmission moment and with reduced transmission force. So, the vehicle door with the clutch in the intermediate engaged state is kept in its current position at any time by the self-locking motor unit, but can be moved by manual actuation with a predetermined minimum actuating force.

In normal operation, the clutch is in the engaged state for motorized actuation. Thus, the clutch works in its nominal mode and preferably with maximum transmission moment and maximum transmission force. In this state, the vehicle door cannot be moved manually. The released state of the clutch is intended for manual movement of the vehicle door in normal operation. Thus, the vehicle door can be manually moved independently of the motor unit.

In particular for emergency operation, for example, due to failure of the voltage supply, the clutch is switched into the intermediate engaged state in which at any time manual movement is possible with a force that is above a predetermined minimum.

Furthermore, the configuration of the gearing as a spindle-spindle nut gear is proposed. In this case, it has been found that suitable design of the spindle-spindle nut gear can be determined by tests with respect to the spindle pitch and the materials used in the spindle-spindle nut gear, so that the intermediate engaged state can also be easily implemented.

In accordance with preferred embodiments of the invention, the spindle-spindle nut gear is specially configured, specifically in the manner of a telescoping jib. In this connection, at least one telescoping sleeve is switched between the spindle and the spindle nut, by which the outside thread of the spindle can be lengthened to a certain extent. Alternatively, the inside thread of the spindle nut can be lengthened by the telescoping sleeve or sleeves. With the aforementioned integration of the telescoping sleeve or sleeves into the spindle-spindle nut gear, a reduction in the length of the spindle-spindle nut gear in the retracted state with the large advance path unchanged is possible.

In the case of a vehicle door that is provided as a side door of a motor vehicle, the configuration of a spindle-spindle nut gear in the manner of a telescoping jib offers special advantages. Because many components are housed in a side door, the possible extension of the drive arrangement in one direction parallel to the lengthwise axis of the motor vehicle is limited. The configuration of a spindle-spindle nut gear in the manner of a telescoping jib makes it possible to greatly reduce the necessary extension in this direction. In this connection, there is an increase in the width of the drive arrangement, and therefore the extension perpendicular to the above addressed direction. For an increase in this direction, generally there is the necessary installation space in the side door.

The invention also relates to preferred versions for the triggering and configuration of a three-stage clutch. In accordance with the invention, the clutch switches automatically into the intermediate engaged state when the control voltage fails, especially in an emergency. This prevents the vehicle door from uncontrolled slamming in an emergency, while ensuring that manual actuation is possible in any situation.

Other details, features, objectives and advantages of this invention are described below in conjunction with the drawings.

### BRIEF DESCRIPTION OF THE DRAWINGS

FIG. 1 shows a side view of a motor vehicle with a side door that has a drive arrangement in accordance with the invention;

FIG. 2A shows a partial side view of a drive arrangement in accordance with the invention from the side door of the vehicle taken along line II-II in FIG. 1 with the drive arrangement in a closed position;

FIG. 2B shows a partial side view of a drive arrangement in accordance with the invention from the side door of the vehicle taken along line 11-11 in FIG. 1 with the drive arrangement in the opened position;

FIG. 3A shows the drive of a drive arrangement in accordance with the invention;

FIG. 3B shows an enlarged detail from FIG. 3A;

FIG. 3C shows an enlarged detail from FIG. 3A;

FIG. 4 shows the components of a spindle-spindle nut gear of the drive arrangement in accordance with another embodiment of the invention; and,

FIG. 5 shows a partial side view of a drive arrangement in accordance with another embodiment of the invention in an opened position.

### DETAILED DESCRIPTION OF PREFERRED EMBODIMENTS

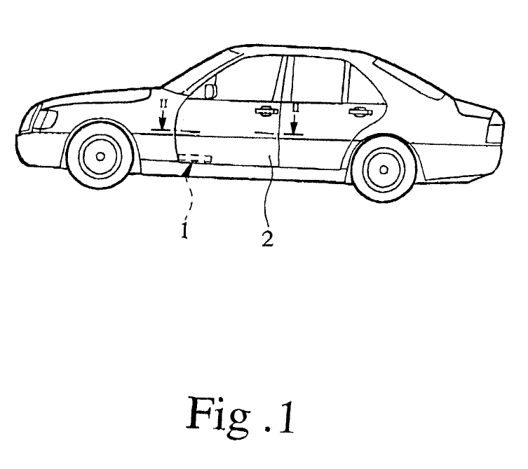

The motor vehicle shown in FIG. 1 is equipped with a drive arrangement 1 for motorized movement of a side door 2. The motor vehicle also shows a trunk lid and a hood, which can be additionally equipped with such a drive arrangement. Basically, the drive arrangement 1 in accordance with this invention can be applied to any type of access opening in a motor vehicle, including a rear hatch, a cargo space hatch or a lifting roof. When the term vehicle door is used herein, it is intended to apply to all types of vehicle doors. The side door is used herein as an exemplary embodiment.

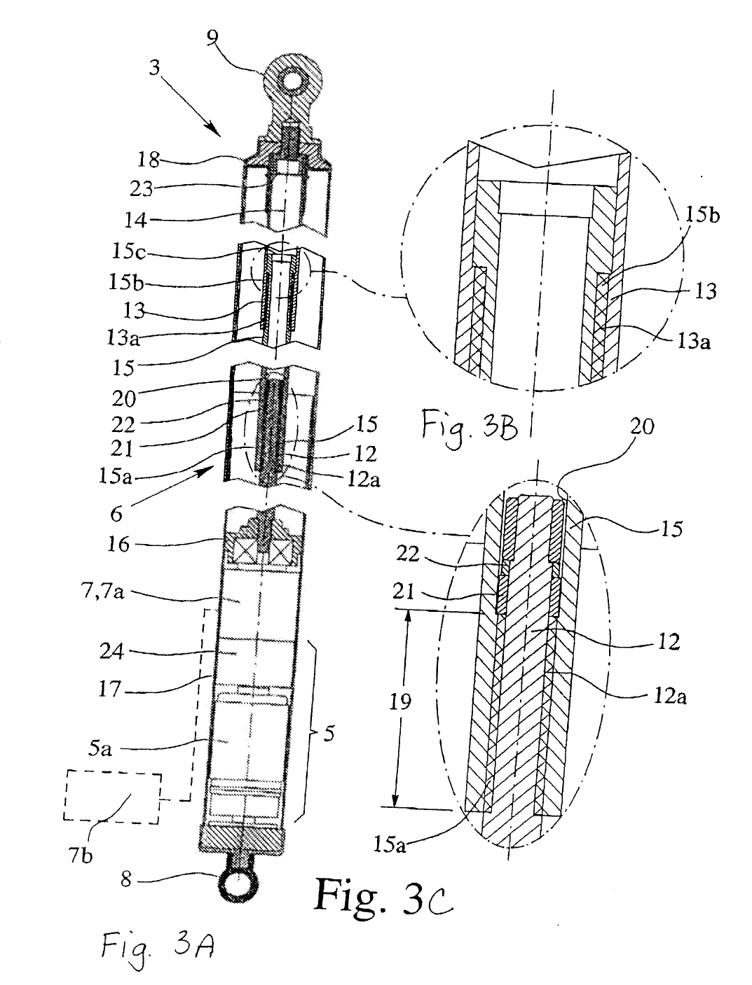

The drive arrangement 1 for motorized movement of the vehicle door 2 is equipped with at least one drive 3, seen in FIG. 3A. Preferably, a single drive 3 is provided, but more drives, such as two drives, can be provided as necessary. In the configuration of the drive arrangement 1 with two drives 3, twisting of the vehicle door 2 can be effectively opposed.

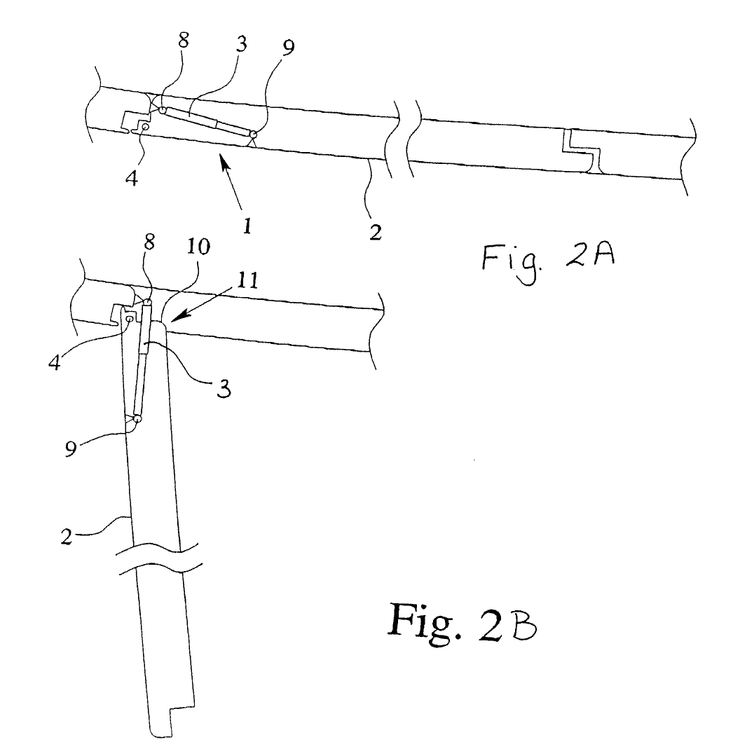

The vehicle door 2 is coupled to the body of the motor vehicle to pivot around a pivoting axis 4, by which an opening in the vehicle body can be closed. The drive 3, shown in FIG. 2A, has a motor unit 5 and a gear 6 connected downstream of the motor unit 5 to produce linear driving movements, as seen in FIG. 3A. The gear 6 is made as a spindle-spindle nut gear so that linear drive movements are produced.

An important aspect for the manner of operation of the drive arrangement 1 is that the motor unit 5 is self-locking, but the spindle-spindle nut gear 6 is not self locking. In the drive line between the motor unit 5 and the spindle-spindle nut gear 6, a clutch 7 is connected, which can be moved into an engaged state, into a released state and into an intermediate engaged state. In the engaged state, the motor unit 5 for nominal operation is engaged by drive engineering to the vehicle door 2, so that when the motor unit 5 has been turned off manual movement of the vehicle door 2 is blocked. The reason for this is the self-locking configuration of the motor unit 5.

When the clutch 7 is in the released state, the motor unit 5 is separated from the vehicle door 2 in terms of drive engineering or disconnected so that the vehicle door 2 can be moved independently of the motor unit 5. This corresponds to the manual actuation of the vehicle door 2 in normal operation.

When the clutch 7 is in the intermediate engaged state, the transmission moment transmitted from the clutch 7 and the transmission force transmitted from the clutch 7 compared to the mode of operation in nominal operation are reduced. When the reduced transmission moment or reduced transmission force is exceeded, the clutch 7 works in the manner of a slip clutch and enables manual actuation of the vehicle door 2. Consequently, the implementation of the intermediate engaged state results in the vehicle door 2 being kept in the engaged state by the self-locking of the motor unit 5 at any time in its current position, but can be moved by manual actuation with a predetermined minimum actuation force. The advantages associated herewith are explained above.

As noted, in this exemplary configuration, the vehicle door 2 is the side door of a motor vehicle. It can be appreciated from FIGS. 2A, 2B, 3A, 3B, & 3C, that the drive 3 has a first point of application of force 8 and a second point of application of force 9 for routing or transmitting the linear drive motion outwardly. In the preferred embodiment shown in FIGS. 2A & 2B, the first point of application of force 8 is coupled to the body of the motor vehicle and the second point of application of force 9 is coupled to the vehicle door 2. The first point of application of force 8 is preferably coupled directly to the body of the vehicle. This means that the first point of application of force 8 is coupled directly to the body of the motor vehicle without additional, interposed transmission elements, pivot joints or the like. In this configuration of the invention, the coupling of the first point of application of force 8 to the body and of the second point of application of force 9 to the vehicle door 2 is made as a direct pivot coupling. This means that preferably the entire drive 3, in any case the spindle-spindle nut gear 6, is moved and pivoted with the motorized movement of the vehicle door 2.

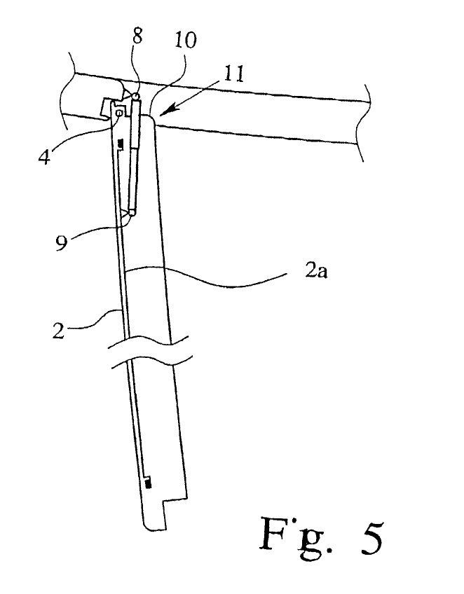

Vehicle doors 2 typically have a door module 2a, seen in FIG. 5, which supports different operating elements, such as the window drive, a speaker or the like. In one preferred configuration, the second point of application of force 9 is coupled to a door module 2a located in the vehicle door 2. The drive 3 can then be mounted on the door module 2a in the manufacture of the motor vehicle during pre-installation of the door module 2a. The drive 3 can be installed together with the door module 2a into the vehicle door 2 in one step and can be coupled to the body of the motor vehicle via the first point of application of force 8.

As shown in FIGS. 2A & 2B, the drive 3 is basically located between the body of the motor vehicle and the vehicle door 2. In this arrangement, the drive 3 with the vehicle door 2 closed is located essentially entirely within the vehicle door 2. With the vehicle door 2 opened, the spindle-spindle nut gear 6 of the drive 3 projects through the opening 10 in the front 11 of the vehicle door. This can also be provided the other way around, specifically with the drive 3 located essentially completely within the body when the door 2 is closed. This can be beneficial, especially for a drive arrangement 1 in a front side door.

In particular, when the vehicle door 2 is configured as a side door, the installation space-optimized configuration of the spindle-spindle nut gear 6 acquires special significance. As noted above, the installation space present in the direction parallel to the lengthwise axis of the motor vehicle is limited since the operating elements, such as the window drive, speaker or the like, are often integrated into the vehicle door. The especially short lengthwise extension of the spindle-spindle nut gear 6 in the aforementioned sense is achieved when the spindle-spindle nut gear 6 is made in the manner of a telescoping jib. This arrangement is shown in FIGS. 3A, 3B, and 3C. It can be appreciated from FIG. 3A that the spindle-spindle nut gear 6 has one spindle 12 with an outside thread 12a and a spindle nut 13 with an inside thread 13a. The linear drive motion, as is fundamentally conventional in spindle-spindle nut gears, is expressed as motion of the spindle nut 13 parallel to the spindle axis 14.

The spindle-spindle nut gear 6 compared to known spindle-spindle nut gears is a modified arrangement in that here at least one telescoping sleeve 15 is provided with an inside thread 15a and an outside thread 15b and is positioned between the spindle 12 and the spindle nut 13. In this case, the spindle 12 is located inside, the telescoping sleeve 15 or sleeves 15 are located farther outside, and the spindle nut 13 is located entirely outside. All of these components have the capacity to telescope and to be screwed into one another, so that each outside thread 12a, 15b forms a thread pairing with the corresponding inside thread 15a, 13a that is adjacent at the time.

The indications “inside” and “outside” relate to the direction that is radial with respect to the spindle axis 14. A “telescoping arrangement” means that the pertinent components 12, 13, 15 are arranged concentrically to the spindle axis 14 so that they can be inter-nested in the manner of a multistage, telescope-like jib. “Thread pairing” means that the respective outside thread 12a, 15b is engaged by threads to the inside thread 13a, 15a that is adjacent at the time.

In the illustrated and preferred embodiment, the spindle 12 is pivotally supported in a pillow block 16. The pillow block 16 is located in a spindle housing 17 on which the first point of application of force 8 of the drive 3 is located. The pillow block 16 is torsionally fixed to the spindle housing 17 and the first point of application of force 8 in the installed state. The spindle 12 is coupled by drive engineering to the first motor unit 5. However, the spindle nut 13 can also be coupled by drive engineering to the motor unit 5, with the spindle 12 then being torsionally fixed.

The spindle nut 13 is located in a spindle nut housing 18, with the second point of application of force 9 of the drive 3 being located on the spindle nut housing 18. The spindle nut housing 18 is torsionally fixed with the point of application of force 9 in the installed state. When drive movements are produced by the motor unit 5, linear relative motion of the two points of application of force 8, 9 to one another takes place. It can be taken from FIG. 3A that the spindle nut housing 18 is arranged in an overlapping manner to the spindle housing 17 so that the inner components are protected against dirt. In this connection, it is noted that the inside thread 13a of the spindle nut 13 can also be fundamentally made as a component of the spindle nut housing 18.

In the preferred and illustrated embodiment, a single telescoping sleeve 15 is provided so that the outside thread 12a of the spindle 12 runs in the inside thread 15a of the telescoping sleeve 15 and the outside thread 15b of the telescoping sleeve 15 runs in the inside thread 13a of the spindle nut 13. In this way, the spindle-spindle nut gear 6 can be moved into the extended state, shown in FIG. 3A, from the retracted state, not shown, by rotating the spindle 12. It can be appreciated from FIG. 3A that the telescoping sleeve 15 in an extended state of the spindle-spindle nut gear 6 constitutes a lengthening of the outside thread 12a of the spindle 12. Conversely, it could also be stated that the telescoping sleeve 15 constitutes a lengthening of the inside thread 13a of the spindle 13. This ensures that in spite of the short length of the spindle-spindle nut gear 6 a considerable advance path can be implemented.

In a further preferred configuration, at least two telescoping sleeves can be provided that are arranged in the manner of a telescope to be able to be screwed into one another. Then, the outside thread of the spindle runs in the inside thread of the inner telescoping sleeve, and the outside thread of the outside telescoping sleeve runs in the inside thread of the spindle nut. Thus, basically, any lengthening of the advance path is possible as long as the requirements for stability of the arrangement are met.

The arrangement is made such that in the motorized movement of the spindle 12 the individual thread pairings are traversed in a predetermined sequence in succession. To accomplish this, it is preferably provided that during traverse of one thread pairing, the other thread pairing is, or other thread pairings are, not traversed, and therefore to a certain extent constitute a rigid connection. When the spindle-spindle nut gear 6 is moved from the retracted state into the extended state, the outside thread pairings are traversed after the inside thread pairings are traversed. In particular, starting from the retracted state, first the outside thread 12a of the spindle runs in the inside thread 15a of the telescoping sleeve 15 so that the telescoping sleeve 15 and thus the spindle nut 13 are moved relative to the spindle housing 17. After traversing this thread pairing, the outside thread 15b of the telescoping sleeve 15 runs in the inside thread 13a of the spindle nut 13 so that the spindle nut 13 is moved relative to the telescoping sleeve 15 and thus further relative to the spindle housing 17. The transition from traversing the initially named thread pairing to traversing the latter thread pairing is detailed below.

In a preferred embodiment, the different thread pairings have different friction values, with the thread pairing to be traversed first preferably having a lower friction value than the thread pairing to be traversed subsequently. This means that starting from the retracted state of the spindle-spindle nut gear 6 first the outside thread 12a of the spindle 12 runs in the internal thread 15a of the telescoping sleeve 15 since the friction value between the spindle 12 and the telescoping sleeve 15 is less than the friction value between the telescoping sleeve 15 and the spindle nut 13, which is torsionally fixed. Of course, this arrangement can be reversed.

The different friction values of the different thread pairings can be implemented, for example, by different materials and/or coatings of the participating components, including the spindle 12, the telescoping sleeve 15 or sleeves and the spindle nut 13.

The transition of traversing one thread pairing to traversing the following thread pairing is significant for the following reasons. After traversing one thread pairing, the component 12, 15, which has the outside thread 12a, 15b of this thread pairing, moves into blocking engagement with the component 15, 13, which has the inside thread 15a, 13a of this thread pairing. In this way, the next thread pairing is then traversed. This is implemented in this embodiment simply. In this case, the inside thread 15a of the telescoping sleeve 15 extends solely over a short lower region 19 of the telescoping sleeve 15 and the remaining inner part of the telescoping sleeve 15 is used as a running surface 20 for a bearing bush 21, which is located on the spindle 12, as seen in FIG. 3C. The bearing bush 21 adjoins a shoulder 22 in the direction of the spindle axis 14. The running surface has a larger diameter than the inside diameter of the inside thread 15a of the telescoping sleeve 15.

If the spindle 12 is now driven from the retracted state, due to the above described layout of the friction values of the thread pairings, first the outside thread 12 of the spindle 12 runs in the inside thread 15a of the telescoping sleeve 15 until the bearing bush 21 reaches the inside thread 15a of the telescoping sleeve 15. In this way, the spindle 12 moves into blocking engagement with the telescoping sleeve 15 so that as the spindle 12 continues to turn the telescoping sleeve 15 is now turned at the same time. This finally leads to the outside thread 15b of the telescoping sleeve 15 running in the inside thread 13a of the spindle nut 13.

Proceeding from the extended state shown in FIG. 3A, the spindle-spindle nut gear 6 can be again transferred into the retracted state by reverse driving of the spindle 12. In this connection, the above described blocking between the spindle 12 and the telescoping sleeve 15 also leads to a predefined blocking of these two components 12, 15. So, the outside thread 15b of the telescoping sleeve 15 runs in the inside thread 13a of the spindle nut 13, which leads to the spindle-spindle nut gear 6 initially being pulled together. As soon as the telescoping sleeve 15 with its front 15c reaches the stop 23 on the spindle nut housing 18, the telescoping sleeve 15 is blocked relative to the spindle nut 13. As the spindle 12 continues to turn, the above described clamping between the spindle 12 and the telescoping sleeve 15 is overcome. So, ultimately the outside thread 12a of the spindle 12 runs in the inside thread 15a of the telescoping sleeve 15, and the spindle-spindle nut gear 6 is transferred into the retracted state.

The above described implementation of the sequential traversal of the thread pairings constitutes a version that can be mechanically implemented especially easily. Other possible implementations are also conceivable.

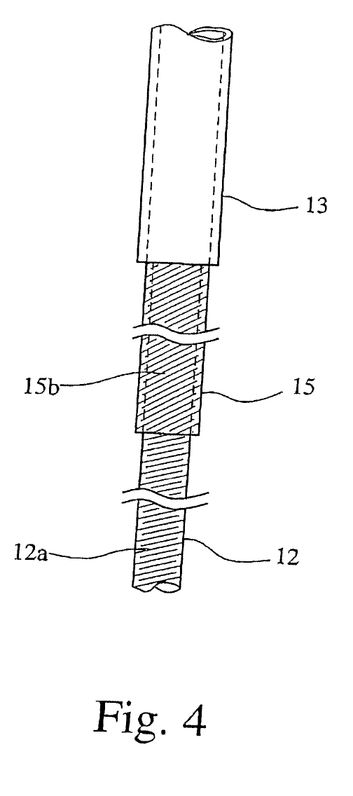

In addition, the above described sequential traversal of the thread pairings can be used to equip the drive 3 of the drive arrangement 1 with different gear stages. As shown schematically in FIG. 4, for this purpose, it is provided that the different thread pairings have different thread pitches. In sequential traversal of the thread pairings, thus different gear stages are implemented that are active or inactive depending on the thread pairing being currently traversed.

According to another configuration, the transmission ratio is additionally variable within a thread pairing. This can be implemented, for example, by forming the thread pairing as a ball groove thread pairing, which has a variable thread pitch over its length. The term “ball groove thread pairing” means a structure in the manner of a ball groove thread spindle in which between the two corresponding threads, in this case between the outside thread of the spindle and the inside thread of the spindle nut, there is a ball set. Thus, within the thread pairing a continuous change of the transmission ratio is realized during traversal of the thread pairing.

The structure of the drive 3 of the drive arrangement 1 is very compact. The motor unit 5 has a drive motor 5a and optional intermediate gearing 24 connected downstream of the drive motor 5a. The self-locking of the motor unit 5 is effected preferably by a spur gear or a planetary gear. Other embodiments of the intermediate gearing 24 are also conceivable. Depending on the application, the intermediate gearing 24 can also be omitted.

Various possibilities are conceivable for how the above described self-locking of the motor unit 5 can be implemented. One possibility is a suitable design of the aforementioned intermediate gearing 24. Another possibility is to design the drive motor 5 itself such that it acts in a self-locking manner within certain limits. Optionally, the desired self-locking characteristic can also be supported by suitable spring pre-tensioning.

In addition or alternatively to the aforementioned intermediate gearing 24, a clutch gear 7a can be provided connected between the clutch 7 and the gear 6. This clutch gear 7a is located on the driven side of the clutch 7 and is made a non-self locking gear to ensure the above described manual movement capacity of the vehicle door 2. With a corresponding design of the clutch gear 7a, the transmission moment to be accommodated by the clutch 7 or the transmission force to be accommodated by the clutch 7 can be greatly reduced. The low transmission moment leads to an especially economical implementation of the clutch 7.

The spindle 12, the optional clutch gear 7a, the clutch 7 and the motor unit 5 are preferably located in direct succession, as viewed along the spindle axis 14. Furthermore, it is preferred that the spindle 12, the optional clutch gear 7a, the clutch 7 and the motor unit 5 are located in an essentially cylindrical housing that extends along the spindle axis 14.

The spindle-spindle nut gear 5 is furthermore equipped with a spring arrangement, which causes pretensioning between the spindle housing 12 and the spindle nut housing 14 in the direction of the extended state.

Control of the three-stage clutch 7 is particularly important so that the above described advantages are ensured. For this purpose, in a preferred configuration a control means 7b is designed for triggering the clutch 7. The control means 7b applies a control voltage to the clutch 7 for triggering.

It is especially advantageous if the clutch 7 switches automatically into the intermediate engaged state when the control voltage ceases. On one hand, this ensures that in an emergency, the door is fixed. On the other hand, fixing the door is possible without any power consumption by interrupting the motorized movement when desired by the user. The vehicle door 2 can therefore be kept in any position without the control means 7b having to apply electrical control power for this purpose.

It can also be provided that the clutch 7 does not generally switch into the intermediate engaged state when the control voltage ceases, but only when the clutch 7 is in the engaged state beforehand. In this configuration, the clutch 7 will remain in the released state when the control voltage has ceased if it is in the released state beforehand. This is also feasible since this released state is generally activated by the user in order to manually actuate the vehicle door 2. In this respect, the failure of the power supply in any case has no adverse effects for manual actuation of the vehicle door 2.

It is especially advantageous when the clutch 7 is made bi-stable with respect to the engaged state and the released state. This means that the clutch 7 remains in one of the two states without further application of a control voltage. In this connection, the clutch 7 can be switched into the intermediate engaged state by a positive control voltage pulse being supplied and into the released state when an opposite, negative control voltage pulse is supplied. Because preferably short control voltage pulses are required for switching of the clutch 7, in turn low power consumption can be expected.

The engaged state can be established in a preferred configuration of the clutch 7 in which the clutch 7 is continuously supplied with a positive control voltage. In this connection, the clutch 7 remains in the engaged state only for the duration of application of the positive control voltage. When the control voltage ceases, the clutch 7 preferably switches into the intermediate engaged state, as explained above.

In the above described preferred configuration of the clutch 7, the clutch 7 can be shifted into discrete states. The clutch 7 can be moved solely into the engaged state, into the released state and into the intermediate engaged state. This leads to an especially simple mechanical implementation of the clutch 7.

In another preferred configuration, the clutch 7 is made as an electromagnetic clutch 7 that has a permanent magnet and an electromagnet. In this connection, the magnetic field of the permanent magnet is sufficient to implement the intermediate engaged state. By intensifying the magnetic field of the permanent magnet with the magnetic field of the electromagnet pointed in the same direction, the engaged state can be implemented. Finally, the released state can be implemented by weakening the magnetic field of the permanent magnet with the opposite magnetic field of the electromagnet. The use of permanent magnets and electromagnets can be implemented in a small installation space. Additionally, noise caused by shifting the clutch 7 is minimized.

The clutch 7 can also be formed as an electromechanical clutch 7 that has an electric motor or the like. An electromagnetic clutch 7 leads to a durable and economical implementation. However, when voltage is applied, more noise is generated than the aforementioned electromagnetic clutch 7.

For actuation of the vehicle door 2 by the user, electrical actuating means are provided. The actuating means can comprise mechanical actuating means such as an inside door handle and/or outside door handle on the vehicle door 2. Alternatively or additionally, there can also be an electrical remote control. It is especially advantageous when the inside door handle and/or outside door handle is provided with corresponding switches or momentary contact actuators so that with a single user motion both a manual actuating force can be applied to the vehicle door 2 and the corresponding switch can be actuated.

In a preferred configuration, the corresponding actuation of the actuating means by the user causes motorized movement of the vehicle door 2. For this purpose, the control means 7b transfers the clutch 7 into the engaged state.

By actuation of the actuating means by the user, the motorized movement of the vehicle door 2 can also be interrupted if desired. The control means 7b switches the clutch 7 into the intermediate engaged state. For this purpose, it is preferably simply provided that the control means 7b turns off the control voltage, as was explained above. As likewise explained above, the vehicle door 2 then maintains its current position, but can be manually moved by applying a minimum actuating force.

In another configuration, the clutch 7 can also be shifted by the user into the released state by actuation of the actuating means. The vehicle door 2 can then be moved manually, independently of the drive 3. After a predetermined waiting time, the control means 7b shifts the clutch 7 preferably back into the intermediate engaged state, provided the actuation of the actuating means by the user does not continue. This has the advantage that independent and uncontrolled movement of the released vehicle door 2 is prevented. For example, it can be imagined that a child actuates the actuating means such that the clutch 7 shifts into the released state. If the vehicle is on an incline, unwanted and sudden closing of the vehicle door 2 could occur, which could lead to a significant risk of injury. In this case, the above addressed automatic transfer of the clutch 7 into the intermediate engaged state briefly after actuation by the user is especially advantageous.

Other operating modes that allow especially intuitive actuation of the vehicle door 2 are conceivable. For instance, motorized movement of the vehicle door 2 can be preceded basically by initial manual movement of the vehicle door 2 by the user. The user therefore pushes the vehicle door to a certain extent, and then the drive arrangement 1 takes over the movement. If there is a measurement means for determining the direction of the initial manual movement, the control means 7b can coordinate the motorized movement of the vehicle door 2 in the desired direction. In particular, in this operating mode to open and close the vehicle door 2, the user first actuates the actuation means and the control means 7b, which thereupon shifts the clutch 7 into the released state so that the user can undertake initial manual movement. Then, the drive arrangement 1 takes over motorized movement, as explained above.

Numerous versions are conceivable for the configuration of the actuating means. For example, the actuating means could be equipped with a single switch or momentary contact actuator. In this connection, to some extent multiple assignment of the switch or actuator is possible. One preferred configuration provides longer actuation of the switch or the actuator to cause the transfer of the clutch 5 into the released state. Actuations in the manner of a double click or the like are also conceivable.

As noted above, the drive arrangement in accordance with this invention has special advantages in emergency operation, especially when the vehicle power supply fails. In the above explained configurations in emergency operation, the intermediate engaged state or the released state is held, so that in any case a limited, manual scope of operation of the vehicle door 2 is ensured.

In one preferred configuration, the voltage supply of the vehicle electrical system is designed to be at least partially redundant. This means that in addition to the vehicle battery for voltage supply of the vehicle's electrical system there is an extra battery for triggering of the clutch 7 in any case. In this connection, the clutch 7 is triggered in normal operation via the vehicle battery. In emergency operation, the triggering of the clutch 7 via an extra battery is provided. The extra battery is preferably located in the vehicle door 2. The overall arrangement is made especially compact when the extra battery is integrated into the actuating means. The extra battery can be a conventional storage battery.

In the above explained concept with an extra battery, it is also possible in emergency operation to shift the clutch 7 into the intermediate engaged state and into the released state. Therefore, both fixing of the vehicle door 2 and motorized movement of the vehicle door 2 with little actuation force are possible. To design the extra battery to be especially economical, triggering of the clutch 7 should be designed to be require as little power consumption as possible. In the above explained configuration, this is the case when the clutch 7 is triggered by control voltage pulses. An extra battery with small dimensions can be used here, which in turn enables simple integration of the extra battery into the actuating means.

Finally, it should be pointed out that an operating mode complementary to the aforementioned operating mode is conceivable. In a complementary operating mode, the clutch 7 is triggered in normal operation via the extra battery and in emergency operation via the vehicle battery. Emergency operation is defined as when the extra battery fails.

In summary, equipping the drive 3 with a spindle-spindle nut gear 6 and with the above described three-stage clutch 7 is optimum both with respect to the required installation space and also with respect to the operating behavior, especially for use in the side door of a vehicle. The advantages with respect to installation space are further enhanced in that the spindle-spindle nut gear 6 can be designed as a telescoping jib. Finally the aforementioned versions of control engineering lead to a reduction of the control engineering cost and at the same time to an increase of operating reliability.

Other modifications and changes are possible within the scope of the invention as defined in the appended claims.

What is claimed is:

1. Drive arrangement for motorized movement of a motor vehicle door coupled to a motor vehicle body around a pivot axis, comprising:
at least one drive having a motor unit and a gear connected downstream of the motor unit for producing linear drive movement, wherein the motor unit is self-locking and the gear is not self locking, and a clutch connected between the motor unit and the gear, wherein the clutch is movable between an engaged state, a released state, and an intermediate engaged state,
wherein when the clutch is moved into the engaged state the motor unit is coupled to the vehicle door and when the motor unit is turned off manual movement of the vehicle door is blocked,
wherein when the clutch is moved into the released state the motor unit is operationally disconnected from the vehicle door, and
wherein when the clutch is moved into the intermediate engaged state, the drive has a reduced transmission moment and a reduced transmission force so that the vehicle door is maintained in its current position at any time by self-locking of the motor unit and is movable by manual actuation with a predetermined minimum actuation force.

2. Drive arrangement as claimed in claim 1, in combination with the vehicle door, and wherein the vehicle door is a side door of a vehicle.

3. Drive arrangement as claimed in claim 1, wherein the drive has a first point of application of force and a second point of application of force for transmitting the linear drive movement outwardly, wherein the first point of application of force is coupled to the body of the motor vehicle and the second point of application of force is coupled to a door module located in the motor vehicle door.

4. Drive arrangement as claimed in claim 1, wherein the gear is a spindle-spindle nut gear.

5. Drive arrangement as claimed in claim 4, wherein when the vehicle door is closed, the drive is located essentially entirely within the vehicle door, and when the vehicle door is opened, the spindle-spindle nut gear projects through an opening in a front of the vehicle door.

6. Drive arrangement as claimed in claim 4, wherein the spindle-spindle nut gear includes a spindle with an outside thread and a spindle nut with an inside thread, wherein the linear drive movement is motion of the spindle nut parallel to the spindle axis, and wherein the spindle-spindle nut gear has at least one telescoping sleeve with an inside thread and an outside thread, and wherein the spindle is located inside the telescoping sleeve and the telescoping sleeve is located inside the spindle nut, each arranged to telescope and to be screwed into one another, so that each outside thread forms a thread pairing with an adjacent inside thread.

7. Drive arrangement as claimed in claim 6, wherein the spindle-spindle nut gear has a single telescoping sleeve, wherein the outside thread of the spindle runs in the inside thread of the telescoping sleeve, and wherein the outside thread of the telescoping sleeve runs in the inside thread of the spindle nut.

8. Drive arrangement as claimed in claim 6, wherein the spindle-spindle nut gear has at least two telescoping sleeves that are telescoping and screwed into one another, wherein the outside thread of the spindle runs in the inside thread of the inner telescoping sleeve and wherein the outside thread of the outside telescoping sleeve runs in the inside thread of the spindle nut.

9. Drive arrangement as claimed in claim 6, wherein under motorized movement of the spindle, the individual thread pairings are traversed in a predetermined sequence in succession.

10. Drive arrangement as claimed in claim 6, wherein different thread pairings have different friction values.

11. Drive arrangement as claimed in claim 6, wherein after traversing one thread pairing, the component of the thread pairing having the outside thread moves into blocking engagement with the component having the inside thread of this thread pairing, and wherein the next thread pairing is traversed.

12. Drive arrangement as claimed in claim 6, wherein the different thread pairings have different thread pitches so that in sequential traversal of the thread pairings different gear stages are implemented.

13. Drive arrangement as claimed in claim 12, wherein the thread pitches of the thread pairings are matched to closing and opening characteristics of the vehicle door so that for a high force requirement one gear stage with a high transmission ratio is actuated and for a low force requirement a gear stage with a low transmission ratio is actuated.

14. Drive arrangement as claimed in claim 1, wherein the motor unit has a drive motor and an intermediate gear connected downstream of the drive motor.

15. Drive arrangement as claimed in claim 1, wherein a non-self locking clutch gear is connected between the clutch and the gear.

16. Drive arrangement as claimed in claim 4, wherein the spindle-spindle nut gear has a spindle with an axis, wherein the spindle, the clutch and the motor unit are located in succession along the axis of the spindle.

17. Drive arrangement as claimed in claim 4, wherein the spindle-spindle nut gear has a spindle with an axis, wherein the spindle, the clutch and the motor unit are located in a generally cylindrical housing that extends along the spindle axis.

18. Drive arrangement as claimed in claim 1, wherein a control is provided for triggering the clutch, wherein the control applies a control voltage to the clutch for its triggering and wherein the clutch shifts from the engaged state into the intermediate engaged state when the control voltage ceases.

19. Drive arrangement as claimed in claim 1, wherein the clutch is shiftable into discrete states, and wherein the clutch is solely movable into the engaged state, into the released state and into the intermediate engaged state.

20. Drive arrangement for motorized movement of a motor vehicle door coupled to a motor vehicle body around a pivot axis, comprising:
at least one drive having a motor unit, a clutch and a spindle-spindle nut gear, each connected in succession downstream of the motor unit for producing linear drive movement, wherein the motor unit is self-locking and the gear is not self locking, wherein the clutch is movable between an engaged state, a released state, and an intermediate engaged state,
wherein when the clutch is moved into the engaged state the motor unit is coupled to the vehicle door and when the motor unit is turned off manual movement of the vehicle door is blocked,
wherein when the clutch is moved into the released state the motor unit is operationally disconnected from the vehicle door, and
wherein when the clutch is moved into the intermediate engaged state, the drive has a reduced transmission moment and a reduced transmission force so that the vehicle door is maintained in its current position at any time by self-locking of the motor unit and is movable by manual actuation with a predetermined minimum actuation force.
